(19) United States
(12) Patent Application Publication
(10) Pub. No.: US 2014/0132039 A1
(43) Pub. Date: May 15, 2014

(54) RECLINING LIFT CHAIR FRAME WITH SCISSOR MECHANISMS

(71) Applicant: HHC CHANGZHOU INC, Changzhou (CN)

(72) Inventors: Guo-Qiu Lu, Changzhou, Jiangsu (CN); Hai-Gang Sheng, Changzhou, Jiangsu (CN)

(73) Assignee: HHC Changzhou Inc, Changzhou (CN)

(21) Appl. No.: 13/724,513

(22) Filed: Dec. 21, 2012

(30) Foreign Application Priority Data
Nov. 12, 2012 (CN) 201220595155.0

(51) Int. Cl. A61G 5/10

(52) U.S. Cl. CPC A61G 5/1056
USPC 297/68

(57) ABSTRACT

The invention relates to a reclining lift chair frame with scissor mechanisms that has a reasonable structural and multifunctional design, is highly reliable, and can implement a lying position, a relaxing position, and a sitting position of a lift chair seat. The reclining lift chair frame includes a deployment mechanism, a footrest mechanism, a backrest mechanism, a mounting and locating mechanism, a support mechanism, and a limit mechanism. Through adjusting the footrest mechanism, the backrest mechanism, the mounting and locating mechanism, and the support mechanism in the lift chair, the lift chair is adjusted among three positions: the lying position, the relaxing position and the sitting position, so as to implement multiple functions in one lift chair. More demanding requirements on the lift chair are met, and costumers can purchase less lift chairs or chairs of different positions, thereby reducing the cost.

### CROSS-REFERENCE TO RELATED PATENT APPLICATION

This application claims priority to and the benefit of, pursuant to 35 USC §119(a), Chinese patent application No. 201220595155.0, filed on Nov. 12, 2012 in the State Intellectual Property Office of P.R. China, entitled “RECLINING LIFT CHAIR FRAME WITH SCISSOR MECHANISMS,” by Guo-Qiu LU and Hai-Gang SHENG, which is incorporated herein by reference in its entirety.

Some references, which may include patents, patent applications and various publications, are cited in a reference list and discussed in the description of this invention. The citation and/or discussion of such references is provided merely to clarify the description of the present invention and is not an admission that any such reference is “currently available” to the invention described herein. All references cited and discussed in this specification are incorporated herein by reference in their entireties and to the same extent as if each reference was individually incorporated by reference.

### FIELD OF THE INVENTION

The present invention generally relates to a lift chair, and more particularly, to a reclining lift chair frame with scissor mechanisms for a lift chair, which is capable of implementing a lying position, a relaxing position and a sitting position of a lift chair seat.

### BACKGROUND OF THE INVENTION

Conventionally, lift chairs on the market only implements one position of a seat, for example, a lying position or a sitting position. A lift chair is folded and unfolded by means of a traction mechanism of the lift chair. The function of the lift chair is simple, so the lift chair cannot be used in inspection and treatment on patients by doctors. For example, a doctor needs to choose a sitting position of the lift chair during inspection, and a relaxing position and lying position of the lift chair during treatment. A lift chair that integrates the above three positions provides multiple choices for the treatment process, which is an advancement in the development of medical lift chair functions.

Therefore, a heretofore unaddressed need exists in the art to address the aforementioned deficiencies and inadequacies.

### SUMMARY OF THE INVENTION

The technical problem to be solved by the present invention is to provide a reclining lift chair frame with scissor mechanisms that has reasonable structural design, is highly reliable, and can implement a lying position, a relaxing position, and a sitting position of a lift chair seat.

To solve the above technical problem, the present invention provides a reclining lift chair frame with scissor mechanisms, which includes: a deployment mechanism, a footrest mechanism, a backrest mechanism, a mounting and locating mechanism, a support mechanism, and a limit mechanism. The deployment mechanism includes a first link, a second link, a third link, a fourth link, a fifth link, a seventh link, an eighth link, and a spindle drive rod. The footrest mechanism includes a first leg rod, a second leg rod, a third leg rod, a fourth leg rod, a foot board support, and a foot rest board. The backrest mechanism includes a back protection plate and a back member. The mounting and locating mechanism includes an L-shaped connecting plate, a mounting plate, and a locating plate. The support mechanism includes a first support rod, a second support rod, a base, and a footing. The limit mechanism includes a first backing A, a second backing B, a third backing C, a fourth backing D, a fifth backing E, a sixth backing F, and a seventh backing G.

The second leg rod is provided with a first limit surface and a second limit surface. The spindle drive rod is provided with a third limit surface. The back protection plate is provided with a fourth limit surface, a tenth limit surface, a twelfth limit surface and a thirteenth limit surface. The second support rod is provided with a fifth limit surface. The eighth link is provided with a sixth limit surface. The fourth leg rod is provided with a seventh limit surface. The second leg rod is provided with an eighth limit surface. The locating plate is provided with a ninth limit surface. The third link is provided with an eleventh limit surface.

The foot rest board is connected to an end of the first leg rod and an end of the second leg rod in a rotating manner through a spindle. The foot board support is connected to the first leg rod and the second leg rod in a rotating manner through a spindle. The third leg rod is respectively connected to the first leg rod and the back protection plate in a rotating manner through a spindle. The fourth leg rod is connected to the second leg rod, the second link, the third link and the back protection plate in a rotating manner through a spindle. The locating plate is respectively connected to the back protection plate, the spindle drive rod and the first support rod in a rotating manner through a spindle. The fourth link is connected to the second link in a rotating manner through a spindle. The seventh link is connected to the first support rod, the first link, and the fifth link in a rotating manner through a spindle. The third link is connected to the fifth link in a rotating manner through a spindle. An end of the first support rod is connected to the base in a rotating manner through a spindle. The first link is connected to the back protection plate, the fifth link, and the seventh link in a rotating manner through a spindle. The back protection plate is connected to the L-shaped connecting plate, the back member, the spindle drive rod and the first link in a rotating manner through a spindle. The eighth link is connected to the back member and the L-shaped connecting plate in a rotating manner through a spindle. An end of the second support rod is connected to the connecting plate in a rotating manner through a spindle, and another end thereof is connected to the base in a rotating manner through a spindle. The mounting plate is connected to the back protection plate through a rivet. The locating plate is connected to the back protection plate, the spindle drive rod, the second link, and the first support rod in a rotating manner through a spindle.

When the reclining lift chair frame with scissor mechanisms for a lift chair is in a sitting position, an included angle between the back member and the floor is about 62°±2°.

When the reclining lift chair frame with scissor mechanisms for a lift chair is in a lying position, an included angle between the back member and the floor is about 15°±2°.

When the reclining lift chair frame with scissor mechanisms for a lift chair is in a relaxing position, an included angle between the back member and the floor is about 57°±2°.

A distance between mounting holes at two ends of the second support rod is about 186.4 mm.

In another aspect, the present invention relates to a lift chair having the reclining lift chair frame as disclosed above.

The present invention has the following beneficial effects: by means of the multifunctional design of the lift chair deployment device, the footrest mechanism, the backrest mechanism, the mounting and locating mechanism, and the support mechanism in the lift chair are adjusted, so as to adjust the lift chair among three positions, namely the lying position, the relaxing position and the sitting position, implementing multiple functions on one lift chair. The requirement for multiple positions on medical lift chair is met, and medical institutes can purchase less lift chairs or chairs of different positions, thereby reducing the cost.

These and other aspects of the present invention will become apparent from the following description of the preferred embodiment taken in conjunction with the following drawings, although variations and modifications therein may be effected without departing from the spirit and scope of the novel concepts of the invention.

### BRIEF DESCRIPTION OF THE DRAWINGS

In order to clearly describe the detailed structure and technical advantages over current products of the reclining lift chair frame with scissor mechanisms, a possible embodiment is described below through a non-limiting example applying the principle and with reference to the accompanying drawings, wherein:

FIG. 1 is a schematic structural view of a deployment mechanism when the reclining lift chair frame with scissor mechanisms is in a lying position;

FIG. 2 is a schematic structural view of a deployment mechanism when the reclining lift chair frame with scissor mechanisms is in a relaxing position; and

FIG. 3 is a schematic structural view of a deployment mechanism when the reclining lift chair frame with scissor mechanisms is in a sitting position.

Meanings of the symbols in the drawings are as follows:
1: foot rest board, 2: first link, 3: first leg rod, 4: foot board support, 5: second leg rod, 6: third leg rod, 7: fourth leg rod, 8: second link, 9: third link, 10: back protection plate, 11: fourth link, 12: spindle drive rod, 13: fifth link, 14: sixth link, 15: first support rod, 16: seventh link, 17: L-shaped connecting plate, 18: second support rod, 19: eighth link, 20: footing, 22: back member, 23: base, 24: mounting plate, 25: locating plate;
A: first backing, B: second backing, C: third backing, D: fourth backing, E: fifth backing, F: sixth backing, G: seventh backing, H: eighth backing;
101: first limit surface, 102: second limit surface, 103: third limit surface, 104: fourth limit surface, 105: fifth limit surface, 106: sixth limit surface.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper”, depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

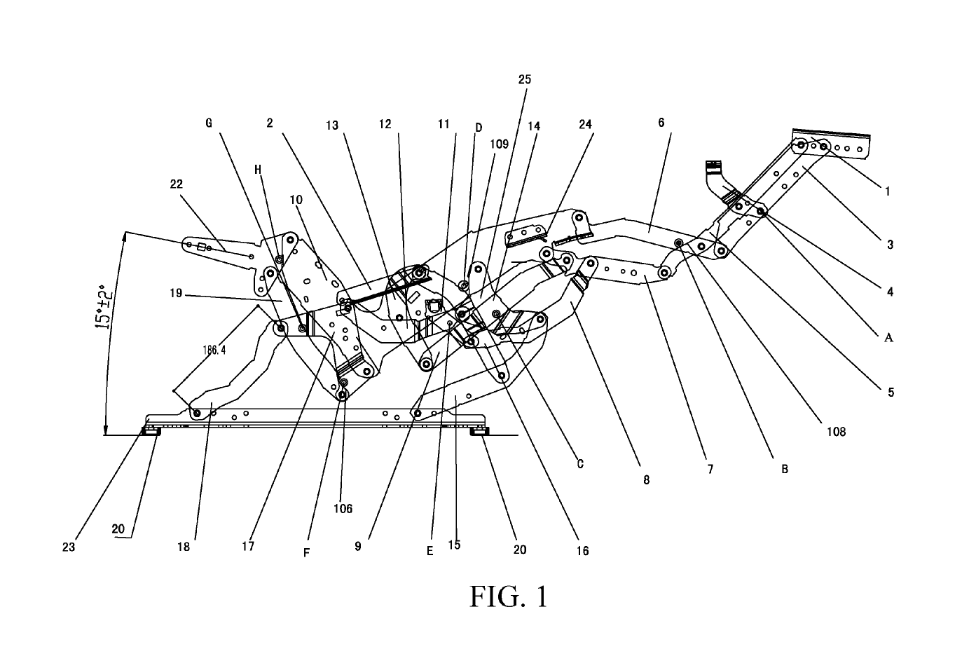

The following description is made as to the embodiments of the present invention in conjunction with the accompanying drawings in FIGS. 1-3.

As shown in FIG. 1 to FIG. 3, a reclining lift chair frame with scissor mechanisms for a lift chair in this embodiment includes: a deployment mechanism, a footrest mechanism, a backrest mechanism, a mounting and locating mechanism, a support mechanism, and a limit mechanism. The deployment mechanism includes a first link 2, a second link 8, a third link 9, a fourth link 11, a fifth link 13, a seventh link 16, an eighth link 19, and a spindle drive rod 12. The footrest mechanism includes a first leg rod 3, a second leg rod 5, a third leg rod 6, a fourth leg rod 7, a foot board support 4, and a foot rest board 1. The backrest mechanism includes a back protection plate 10 and a back member 22 that are L-shaped. The mounting and locating mechanism includes an L-shaped connecting plate 17, a mounting plate 24, and a locating plate 25. The support mechanism includes a first support rod 15, a second support rod 18, a base 23, and a footing 20. The limit mechanism includes a first backing A, a second backing B, a third backing C, a fourth backing D, a fifth backing E, a sixth backing F, a seventh backing G, and an eighth backing H. In a lying position, the eighth backing H has a limit function.

The second leg rod 5 is provided with a first limit surface 101 and a second limit surface 102. The spindle drive rod 12 is provided with a third limit surface 103. The back protection plate 10 is provided with a fourth limit surface 104, a tenth limit surface 110, a twelfth limit surface 112, and a thirteenth limit surface 113. The second support rod 18 is provided with a fifth limit surface 105. The eighth link 19 is provided with a sixth limit surface 106. The fourth leg rod 7 is provided with a seventh limit surface 107. The second leg rod 5 is provided with an eighth limit surface 108. The locating plate 25 is provided with a ninth limit surface 109. The third link 9 is provided with an eleventh limit surface 111. A distance between mounting holes at two ends of the second support rod 18 is about 186.4 mm.

The foot rest board 1 is connected to an end of the first leg rod 3 and an end of the second leg rod 5 in a rotating manner through a spindle. The foot board support 4 is connected to the first leg rod 3 and the second leg rod 5 in a rotating manner through a spindle. The third leg rod 6 is respectively connected to the first leg rod 3 and the back protection plate 10 in a rotating manner through a spindle. The fourth leg rod 7 is connected to the second leg rod 5, the second link 8, the third link 9, and the back protection plate 10 in a rotating manner through a spindle. The locating plate 25 is respectively connected to the back protection plate 10, the spindle drive rod 12, and the first support rod 15 in a rotating manner through a spindle. The fourth link 11 is connected to the second link 8 in a rotating manner through a spindle. The seventh link 16 is connected to the first support rod 15, the first link 2, and the fifth link 13 in a rotating manner through a spindle. The third link 9 is connected to the fifth link 13 in a rotating manner through a spindle. An end of the first support rod 15 is connected to the base 23 in a rotating manner through a spindle. The first link 2 is connected to the back protection plate 10, the fifth link 13, and the seventh link 16 in a rotating manner through a spindle. The back protection plate 10 is connected to the L-shaped connecting plate 17, the back member 22, the spindle drive rod 12, and the first link 2 in a rotating manner through a spindle. The eighth link 19 is connected to the back member 22 and the L-shaped connecting plate 17 in a rotating manner through a spindle. An end of the second support rod 18 is connected to the connecting plate 17 in a rotating manner through a spindle, and another end thereof is connected to the base 23 in a rotating manner through a spindle. The mounting plate 24 is connected to the back protection plate 10 through a rivet. The locating plate 25 is connected to the back protection plate 10, the spindle drive rod 12, the second link 8, and the first support rod 15 in a rotating manner through a spindle.

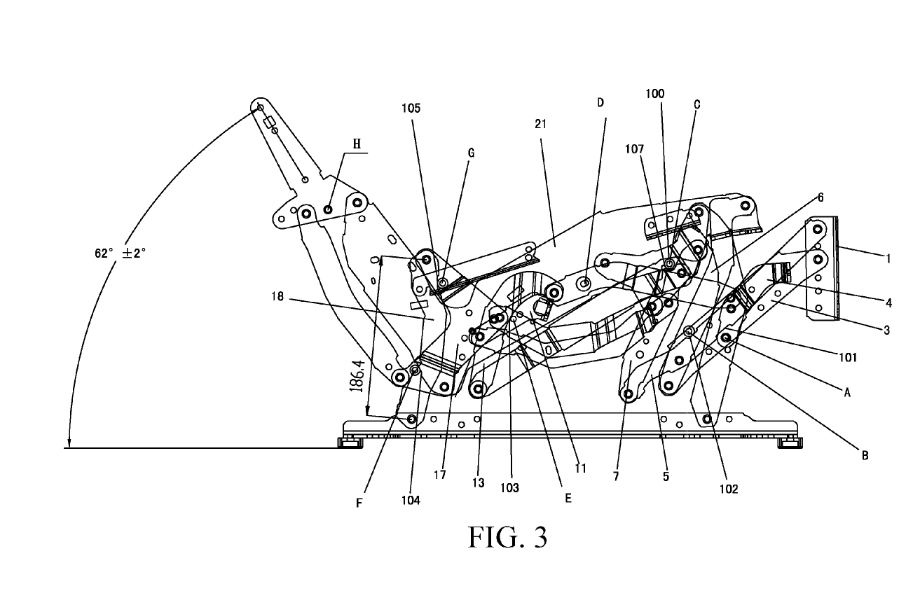

When the reclining lift chair frame with scissor mechanisms for a lift chair is in a sitting position, as shown in FIG. 3, the first leg rod 3, the foot board support 4, and the second leg rod 5 are in a contracted state. The backing A on the foot board support contacts the first limit surface 101 on the second leg rod 5. The backing B on the third leg rod 6 contacts the second limit surface 102 on the second leg rod 5. The backing C on the locating plate 25 contacts the seventh limit surface 107 on the fourth leg rod 7 and the thirteenth limit surface 113 on the back protection plate 10. The backing E on the fourth link 11 contacts the third limit surface 103 on the fifth link 13. The backing F on the L-shaped connecting plate 17 contacts the fourth limit surface 104 on the back protection plate 10. The backing G on the L-shaped connecting plate 17 contacts the fifth limit surface 105 on the second support rod 18. When the lift chair is in the sitting position, the weight of a person is transferred to the base through the above backings and limit surfaces. Therefore, good contact is required between the backings and the limit surfaces. An included angle between the back member 22 and the floor is about 62°, so the back of a patient leans against the back member 22, facilitating inspection on the patient by a doctor.

When the reclining lift chair frame with scissor mechanisms for a lift chair is in a lying position, as shown in FIG. 1, the backing B on the third leg rod 6 contacts the limit surface 108 on the second leg rod 5. The backing D on the back protection plate 10 contacts the limit surface 109 on the locating plate 25. The backing F on the L-shaped connecting plate 17 contacts the limit surface 106 on the eighth link 19. The above backings and limit surfaces are capable of bearing the weight of a person and limiting the position of each mechanism, so that the lift chair is maintained at the lying position. An included angle between the back member 22 and the floor is about 15°, the head of a patient lying on the lift chair is higher, and an angle is included between the head and the body of the patient, facilitating communication between the patent and the doctor.

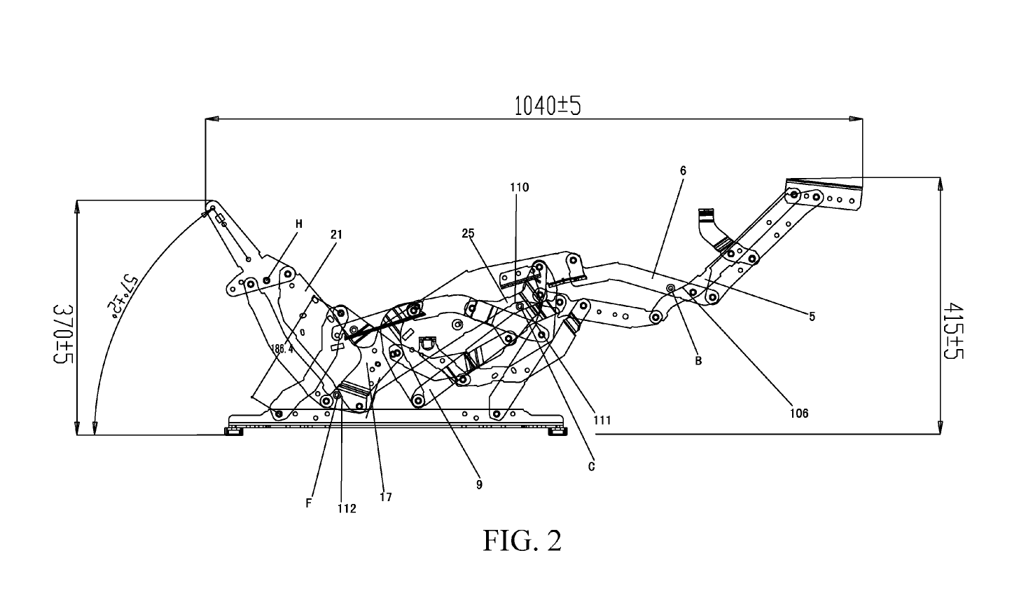

When the reclining lift chair frame with scissor mechanisms for a user is in a relaxing position, as shown in FIG. 2, the backing C on the locating plate 25 contacts the limit surface 110 on the back protection plate 10 and the limit surface 111 on the third link 9. The backing F on the L-shaped connecting plate 17 contacts the limit surface 112 on the back protection plate 10. The above backings bear the weight of a person and limit the relative position of each mechanism, so that the lift chair is maintained at the relaxing position. An included angle between the back member 22 and the floor is about 57°. The relaxing position is higher than the lying position; a person is in a half-sitting half-lying posture, and the head of the person is as high as the foot rest board 1.

The embodiment applying the creative principle of the present invention is described above so as to provide a non-limiting example of the principle within the scope of the claims. For example, the size of the lift chair is variable according the size of the link. The shapes of the links and plates are adjustable according to the customer requirement; the positions of the backings on the links and plates are adjustable according to the height and length of the lift chair at three positions; the backrest mechanism and footrest mechanism are adjustable according the customer requirements.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A reclining lift chair frame, comprising:
a deployment mechanism;
a footrest mechanism;
a backrest mechanism;
a mounting and locating mechanism;
a support mechanism; and
a limit mechanism;
wherein the deployment mechanism comprises a first link, a second link, a third link, a fourth link, a fifth link, a seventh link, an eighth link, a spindle drive rod;
wherein the footrest mechanism comprises a first leg rod, a second leg rod, a third leg rod, a fourth leg rod, a foot board support, and a foot rest board;
wherein the backrest mechanism comprises a back protection plate and a back member;
wherein the mounting and locating mechanism comprises an L-shaped connecting plate a, mounting plate, and a locating plate;
wherein the support mechanism comprises a first support rod, a second support rod, and a base;
wherein the second leg rod is provided with a first limit surface and a second limit surface, the spindle drive rod is provided with a third limit surface, the back protection plate is provided with a fourth limit surface, the second support rod is provided with a fifth limit surface, the eighth link is provided with a sixth limit surface, and the fourth leg rod is provided with a seventh limit surface;
wherein the foot rest board is connected to an end of the first leg rod and an end of the second leg rod in a rotating manner through a spindle, the foot board support is connected to the first leg rod and the second leg rod in a rotating manner through a spindle, the third leg rod is respectively connected to the first leg rod and the back protection plate in a rotating manner through a spindle; the fourth leg rod is connected to the second leg rod, the second link, the third link, and the back protection plate in a rotating manner through a spindle;
wherein the locating plate is respectively connected to the back protection plate, the spindle drive rod, and the first support rod in a rotating manner through a spindle; the fourth link is connected to the second link in a rotating manner through a spindle, the seventh link is connected to the first support rod, the first link, and the fifth link in a rotating manner through a spindle; the third link is connected to the fifth link in a rotating manner through a spindle, an end of the first support rod is connected to the base in a rotating manner through a spindle; the first link is connected to the back protection plate, the fifth link, and the seventh link in a rotating manner through a spindle, the back protection plate is connected to the L-shaped connecting plate, the back member, the spindle drive rod and the first link in a rotating manner through a spindle, the eighth link is connected to the back member and the L-shaped connecting plate in a rotating manner through a spindle;
wherein an end of the second support rod is connected to the connecting plate in a rotating manner through a spindle, and another end thereof is connected to the base in a rotating manner through a spindle; the mounting plate is connected to the back protection plate through a rivet; and
wherein the locating plate is connected to the back protection plate, the spindle drive rod, the second link, and the first support rod in a rotating manner through a spindle.

2. The reclining lift chair frame according to claim 1, wherein when the reclining lift chair frame is in a sitting position, an included angle between the back member and a floor is about 62°±2°.

3. The reclining lift chair frame according to claim 1, wherein when the reclining lift chair frame is in a lying position, an included angle between the back member and a floor is about 15°±2°.

4. The reclining lift chair frame according to claim 1, wherein when the reclining lift chair frame is in a relaxing position, an included angle between the back member and a floor is about 57°±2°.

5. The reclining lift chair frame according to claim 1, wherein a distance between mounting holes at two ends of the second support rod is about 186.4 mm.

6. A lift chair, comprising the reclining lift chair frame as claimed in claim 1.
